(19) United States
(12) Patent Application Publication
(10) Pub. No.: US 2013/0309988 A1
(43) Pub. Date: Nov. 21, 2013

(54) APPARATUS AND METHODS FOR ADJUSTING ADAPTIVE CONTROL LOOP BEHAVIOR BASED ON MEASURED ARTIFACTS

(71) Applicant: Apple Inc., (US)

(72) Inventors: Zhu Ji, Cupertino, CA (US); Navid Damji, Cupertino, CA (US); Johnson O. Sebeni, Fremont, CA (US)

(73) Assignee: Apple Inc., Cupertino, CA (US)

(21) Appl. No.: 13/861,988

(22) Filed: Apr. 12, 2013

Related U.S. Application Data
(60) Provisional application No. 61/624,203, filed on Apr. 13, 2012.

(51) Int. Cl. H04B 1/10

(52) U.S. Cl. CPC H04B 1/1027
USPC 455/234.1

(57) ABSTRACT

Methods and apparatus for adjusting adaptive control loop behavior based on, for example measured artifacts of the radio environment. In one embodiment, a Long Term Evolution (LTE) user equipment (UE) adjusts one or more Automatic Gain Control (AGC) loops based on a measured Doppler spread of received signals. Specifically, one or more AGC parameters (e.g., set-point, loop gain, etc.) are selected based on a measured Doppler spread. The one or more AGC parameters are configured to optimize both the AGC headroom (e.g., dynamic range) and the signal to quantization plus noise ratio (SQNR) of the receiver under dynamic wireless fading channels for the detected Doppler.

### PRIORITY

The present application claims priority to U.S. Provisional Patent Application Ser. No. 61/624,203 filed Apr. 13, 2012 of the same title, the foregoing being incorporated herein by reference in its entirety.

### BACKGROUND

1. Technical Field

The present disclosure relates generally to the field of wireless communication and data networks. More particularly, in one exemplary embodiment, methods and apparatus for adjusting adaptive control loop behavior based on measured artifacts of the radio environment.

2. Description of Related Technology

Automatic gain control (AGC) is a feedback scheme found in many electronic devices to compensate for large fluctuations in e.g., signal amplitude, signal strength, energy, power. Typically, AGC circuits adjust an amplifying (or attenuating) “gain” to maintain a desired output level over a range of input. For example, an AGC circuit will attenuate strong signals, and amplify weak signals, so as to reduce practical component limitations (e.g., saturation, quantization error, etc.). AGC circuits are widely used in radio transceivers to compensate for the rapid changes to received signal strength of wireless signals in dynamically changing environments.

For example, within Long Term Evolution (LTE) cellular networks, LTE radio transceivers commonly employ both analog and digital AGC circuits. One exemplary radio transceiver includes two (2) AGC circuits: a radio frequency (RF) AGC (RAGC), and a digital variable gain amplifier (DVGA). The RAGC controls a low noise amplifier (LNA). An ideal RAGC ensures that the LNA maximizes Signal to Noise Ratio (SNR) of a received signal, while simultaneously ensuring that the received signal remains within the dynamic range of other RF/analog components. Specifically, the received signal should remain within acceptable maxima and minima, and minimize the distortion errors of subsequent digitalization (i.e., avoiding either clipping and/or quantization errors). Similarly, the DVGA adjusts signal levels of the digitized input signal to support stable demodulation performance of the received signals.

Multiple factors can affect AGC performance. Generally, AGC implementations must provide acceptable performance over a wide range of changing parameters throughout operation, including without limitation: signal loading, Doppler-dependent wireless channel fading, and transceiver design constraints. Specifically, AGC control loops must be able to track rapid changes in Doppler-dependent fading scenarios, while still minimizing the receiver signal-to-quantization-plus-noise ratio (SQNR).

Unfortunately, overly conservative AGC operation cannot keep up with rapid fading scenarios (i.e., the AGC cannot compensate for fades quickly enough), whereas overly aggressive AGC operation will introduce quantization and noise, significantly impairing transceiver operation.

Accordingly, improved solutions are needed for adjusting control loop behavior for use in, inter alia, cellular wireless systems.

### SUMMARY

The foregoing needs are satisfied herein by providing, inter alia, improved methods and apparatus for adjusting adaptive control loop behavior based on measured artifacts of the radio environment.

A wireless mobile apparatus is disclosed. In one embodiment, the apparatus includes a long term evolution (LTE)-enabled wireless interface with an adaptive control loop; a processor in data communication with the wireless interface; and logic in data communication with the processor. In one variant, the logic is configured to select one or more automatic gain control (AGC) parameters associated with the adaptive control loop based on one or more detected Doppler-related artifacts of a radio environment in which the mobile apparatus operates, the one or more AGC parameters configured to optimize bath (i) AGC dynamic range, and (ii) signal-to-quantization-plus-noise ratio (SQNR) of the interface under dynamic wireless fading conditions.

In another embodiment, the apparatus includes a wireless interface with an adaptive control loop; a processor in data communication with the wireless interface; and logic in data communication with the processor and configured to dynamically adjust behavior of the adaptive control loop based on one or more Doppler-related artifacts of a radio environment in which the mobile apparatus operates.

A method for adjusting adaptive control loop behavior is disclosed. In one embodiment, the method includes: receiving one or more inputs; estimating one or more artifacts of a radio environment from the received one or more inputs; determining one or more parameters configured to enable adaptive control loop behavior based on the estimated one or more artifacts of the radio environment; and configuring the adaptive control loop according to the determined one or more parameters.

A wireless base station apparatus is disclosed. In one embodiment, the apparatus includes: a wireless interface; a processor in data communication with the wireless interface; and logic in data communication with the processor. In one variant, the logic is configured to: dynamically determine one or more parameters useful in adjusting an adaptive control loop function of a wireless mobile device based on a radio environment in which the base station apparatus communicates with the wireless mobile device; and transmit the determined one or more parameters to the wireless mobile device.

A computer-readable storage apparatus is disclosed. In one embodiment, the apparatus has a storage medium with at least one computer program stored thereon, the at least one program that, when executed on a processing apparatus of a wireless device having an adaptive control loop, causes the wireless device to: receive one or more radio frequency inputs; determine one or more artifacts of a radio environment from the received one or more inputs; determine one or more parameters that enable adaptive control loop behavior based on the determined one or more artifacts of the radio environment; configure the adaptive control loop according to the determined one or more parameters; and perform the determination of the one or more artifacts at least periodically so as to dynamically adjust the control loop for the prevailing radio environment.

A method of producing a reduced complexity wireless transceiver is disclosed. In one embodiment, the method includes: providing a design of logic configured to adaptively control an automatic gain control (AGC) portion of the wireless transceiver; designing the AGC portion to a lower performance level that would be required for the same transceiver without the logic; and fabricating the transceiver based on the design of the logic and the AGC portion. In one variant, the fabricated transceiver is less complex and consumes less electrical power when operating than said same transceiver without the logic.

A wireless system is disclosed. In one embodiment, the system includes at least one base station and at least one wireless mobile device with dynamic AGC control. In one variant, the base station feeds the mobile device information necessary to assess the prevailing radio environment, and derive parameters necessary to implement the aforementioned dynamic control of an AGC function, In another variant, the base station feeds the mobile device the parameters directly based on, e.g., its own assessment of the radio environment.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a logical block diagram illustrating one exemplary Long Term Evolution (LTE) cellular network system useful with various principles described herein.

FIG. 2 illustrates first and second digital representations of a typical analog waveform and typical prior art representations thereof.

FIG. 3A is a block diagram illustrating one exemplary receiver architecture that includes two (2) AGC control loops useful with various principles described herein.

FIG. 3B is a generalized graphical representation of an Automatic Gain Control (AGC) control loop structure, such as may be used in the architecture of FIG. 3A.

FIG. 4 is a logical flow diagram which depicts one generalized method for adjusting adaptive control loop behavior based on measured artifacts of the radio environment, according to the disclosure.

FIG. 5 is a logical flow diagram depicting one exemplary embodiment of a method for configuring Adaptive Automatic Gain Control (AGC) based on Doppler spread observed by a wireless receiver, according to the disclosure.

FIG. 6 is a functional block diagram of an exemplary embodiment of a user equipment (UE) configured according to the present disclosure, including adaptive loop behavioral adjustment.

All Figures © Copyright 2012-2013 Apple Inc. All rights reserved.

### DETAILED DESCRIPTION

Reference is now made to the drawings, wherein like numerals refer to like parts throughout.

### Overview

Methods and apparatus for adjusting Automatic Gain Control (AGC) are disclosed. In one exemplary implementation, the adjustments are based on one or more estimations of a Doppler spread of received signals. Specifically, one or more AGC parameters (e.g., set-point, loop gain, etc.) are selected based on a detected Doppler effect. The one or more AGC parameters are configured to optimize both the AGC headroom (e.g., dynamic range) and the signal to quantization plus noise ratio (SQNR) of the receiver under dynamic wireless fading channels for the detected Doppler. Unlike existing solutions for AGC control loops, the Doppler-dependent adaptive AGC of the present disclosure advantageously adjusts its operation based according to the current radio environment.

More generally, various disclosed embodiments are directed to adjusting adaptive control loop behavior based on measured or in situ artifacts; e.g., those of the radio environment. By ensuring that control loop behavior is specifically targeted to the current radio environment, the control loop does not have to be over-designed to support conservative safety margins (which may not be representative of actual operating environments), and overly fast tracking capabilities. Instead, targeted control loop behavior can be tailored to the exact radio environment in which the device is operating. More reasonable design constraints (e.g., less conservative safety margins, and slower tracking requirements) results in less complex, and more efficient designs.

Various other principles described herein will be apparent to those of ordinary skill in the related arts, given the contents of the present disclosure.

### Detailed Description of Exemplary Embodiments

Exemplary embodiments are now described in detail. While the following discussions are presented within the context of Long Term Evolution (LTE) cellular networks, it will be recognized by those of ordinary skill that the present disclosure is not so limited, and can be used with other cellular technologies such as e.g., TD-LTE (Time-Division Long-Term Evolution), TD-LTE-Advanced, TD-SCDMA (Time Division Synchronous Code Division Multiple Access), Global System for Mobile Communications (GSM), General Packet Radio Service (GPRS) Universal Mobile Telecommunications System (UMTS), etc. In fact, the various principles described herein are useful in combination with any network (cellular, wireless, wired, or otherwise) that can benefit from adaptive control loop behavior which can benefit from dynamic configuration based on measured artifacts of the radio environment,

### Exemplary LTE Network Architecture—

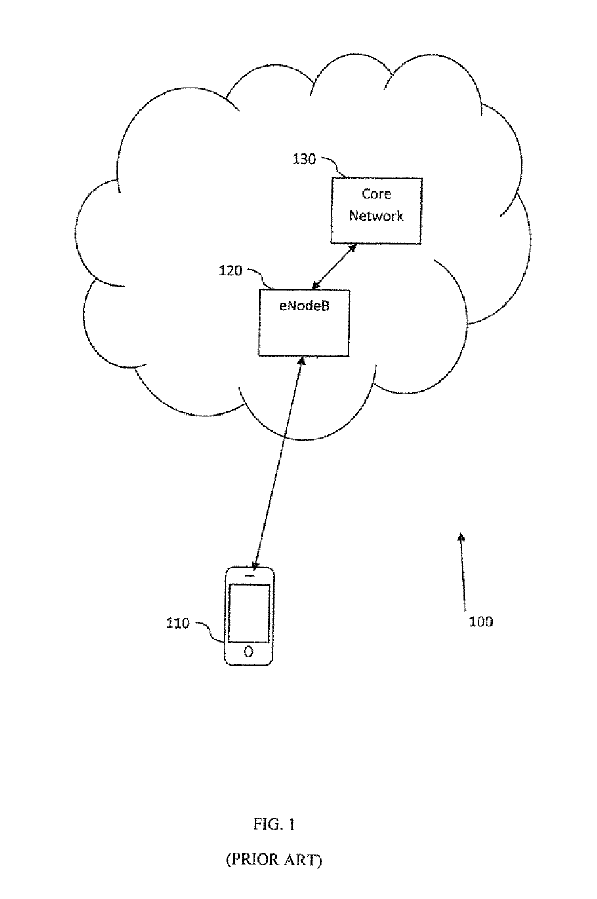

FIG. 1 illustrates one exemplary Long Term Evolution (LTE) cellular network 100, with user equipments (UEs) 110, operating within the coverage of the Radio Access Network (RAN) provided by a number of base stations (BSs) 120. The LTE base stations are commonly referred to as “Enhanced NodeBs” (eNBs). The Radio Access Network (RAN) is the collective body of eNBs along with the Radio Network Controllers (RNC). The user interfaces to the RAN via the UE, which in many typical usage cases is a cellular phone or smartphone. However, as used herein, the terms “UE”, “client device”, and “user device” may include, but are not limited to, cellular telephones, smartphones (such as for example an iPhone™ manufactured by the Assignee hereof), personal computers (PCs), such as for example an iMac™, Mac Pro™, Mac Mini™ or MacBook™, and minicomputers, whether desktop, laptop, or otherwise, as well as mobile devices such as handheld computers, PDAs, personal media devices (PMDs), such as for example an iPod™, or any combinations of the foregoing.

Each of the eNBs 120 are directly coupled to the Core Network 130 e.g., via broadband access. Additionally, in some networks the eNBs may coordinate with one another, via secondary access. The Core Network provides both routing and service capabilities. For example, a first UE connected to a first eNB can communicate with a second UE connected to a second eNB, via routing through the Core Network. Similarly, a UE can access other types of services e.g., the Internet, via the Core Network.

Typical LTE devices implement various forms of signal conditioning, including Automatic Gain Control (AGC). In traditional transceiver designs, an Automatic Gain Control (AGC) module amplifies or attenuates the total received signal to maintain a relatively constant signal for receiver digital baseband processing. In particular, consumer electronics are designed with fixed-point arithmetic (in contrast, floating-point arithmetic represents numbers with a mantissa and exponent). Fixed-point arithmetic can be signed, unsigned, complement, etc. Ideally, the entire dynamic range of the conditioned analog waveform can be fully represented within a fixed-point analog-to-digital (A/D) conversion with the proper application of control loop operation.

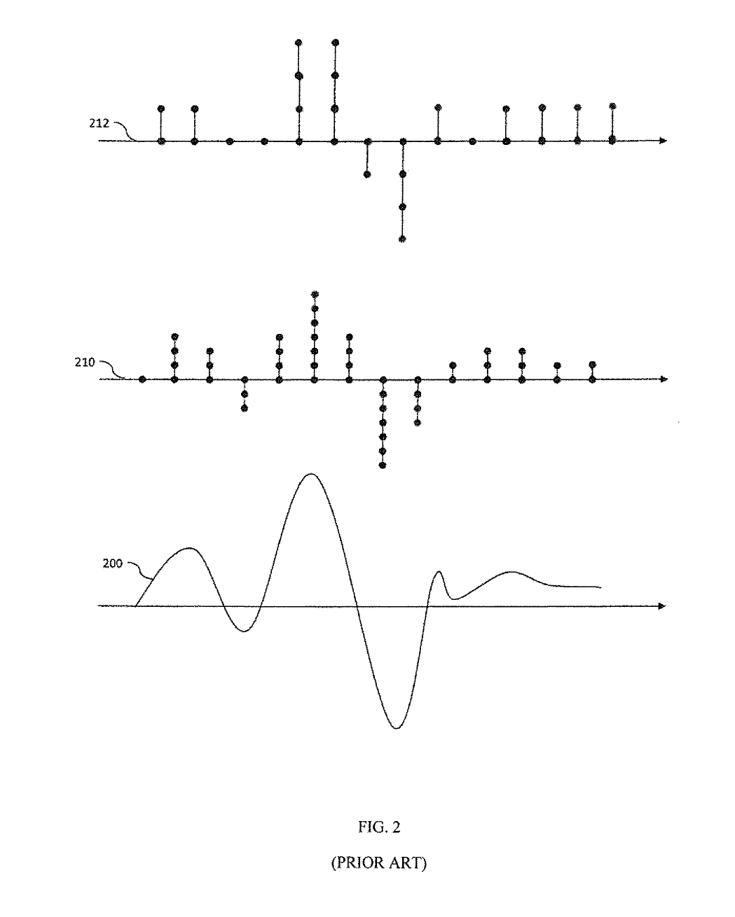

Consider the diagram of FIG. 2, which illustrates first and second digital representations (210, 212 on FIG. 2) of an analog waveform 200. The depicted digital representations illustrate the effects of over-amplification, and over-attenuation, common in various prior art implementations. The first fixed-point representation 210 has difficulty representing peaks and troughs of the waveform; these artifacts saturate the fixed point A/D components, causing distortions or “clipping” effects. Similarly, the second fixed-point representation 212 does not have enough granularity to fully represent the waveform 200.

Within the foregoing discussion, it is readily appreciated that the relative complexity and sensitivity of the transceiver significantly impacts the requirements for fixed-point AID component selection. Simple radio waveforms in low-noise operating environments, etc. can support fixed-point components with less resolution. Proper tuning of AGC operation ensures that the entire dynamic range of the signal is preserved.

### Automatic Gain Control (AGC)—

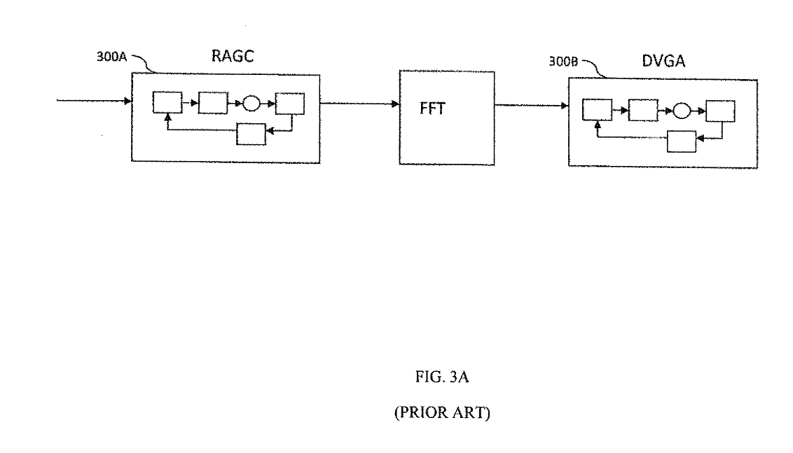

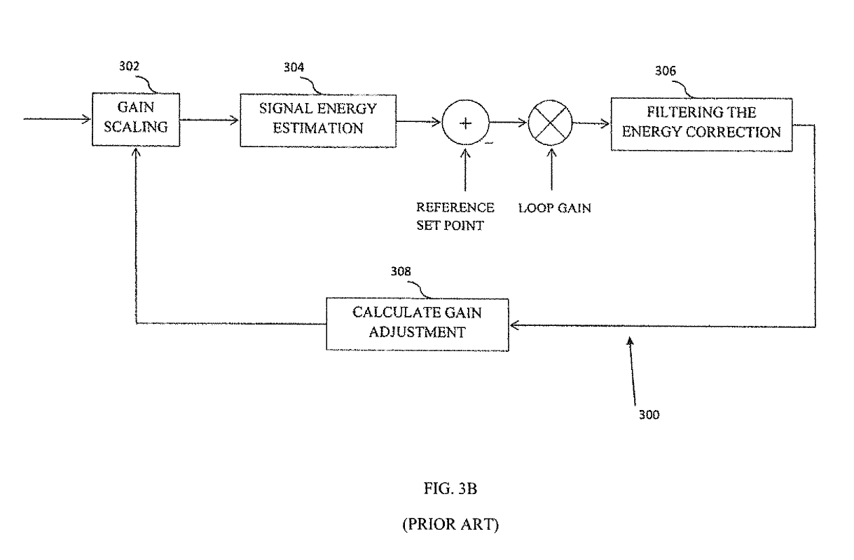

FIG. 3A illustrates one exemplary receiver architecture that includes two (2) AGC control loops: a first outer loop radio frequency (RF) AGC (RAGC) 300A, and a second inner loop digital variable gain control (DVGA) 300B. The RAGC conditions an input analog signal for a processing block (such as a Fast Frequency Transform (FFT) useful within an LTE receiver), whereas the DVGA conditions the output of the FFT for digital processing. While the exemplary receiver architecture of FIG. 3A has been provided for clarity, it is appreciated that the functionality of AGC operation is not significantly different between the RAGC and DVGA.

Referring now to FIG. 3B, one generalized graphical representation 300 of an Automatic Gain Control (AGC) control loop structure is presented. As shown, the AGC control loop includes: (i) a gain scaling block 302, (ii) an energy estimation block 304, (iii) a filtering error correction block 306, and (iv) a gain adjustment calculation block 308.

The gain scaling block 302 receives an input signal, and multiplies the signal by an adjusted gain factor. The adjusted gain factor can either amplify or attenuate the input signal. The adjusted gain factor is determined based on the remaining portions of the feedback chain.

The energy estimation block 304 estimates the signal energy of the gain scaled input signal. The result of the energy estimation block is compared to a reference “set point”. The reference set point is in one implementation a scalar value which the control loop is configured to maintain; thus, if the result of the energy estimation block exceeds the set point, then the feedback value is negative (resulting in an attenuating feedback signal), similarly if the result of the energy estimation block falls below the set point, then the feedback value is positive (resulting in an amplifying feedback signal).

While the foregoing example is based on energy estimation, it should be appreciated that the estimation block may estimate or measure amplitudes, power, etc., with energy estimation being merely illustrative of one exemplary embodiment.

Moreover, within the context of the exemplary receiver architecture of FIG. 3A, for outer loop operation (RAGC), the energy estimation block operates on the input signal to the receiver in the analog domain (i.e., the wideband input signal before the down-sampling to the digital domain). For inner loop operation (DVGA), energy estimation is performed on digital samples to adjust them to an appropriate reference level.

Referring back to FIG. 3B, the filter error correction block 306 implements a filter to prevent large and/or aberrant swings in feedback (e.g., overshoot, undershoot, ringing effects, etc.). The filter error correction block design is entirely design-dependent; however, common implementations are based on e.g., a Finite Impulse Response (FIR), and Infinite Impulse Response (HR) filters. The filter error correction block generally moderates the value of the resulting feedback value by smoothing out large swings.

Based on the smoothed feedback value, the gain adjustment calculation block 308 determines an appropriate adjusted gain factor (see gain scaling block 302).

Unfortunately, AGC control loop operation is significantly complicated by multiple (and sometimes contradictory) considerations. For example, AGC operation must handle varying degrees of: signal loading, radio effects, physical design constraints, and so-called “jammers”, described hereinafter.

Generally, signal loading is based on scheduling which is controlled by network management entities (e.g., base station(s) (BS)). Unfortunately, certain networks require “blind” detection techniques for receiving control information. For example, within LTE networks, the eNB, dynamically schedules the physical control channel (PDCCH). The UE must decode the PDCCH “blindly” to determine if there are any downlink (DL) physical shared channel (PDSCH) allocations. Since the UE doesn't know the signal loading until after the AGC loop has already started, AGC designs are budgeted around the most conservative signal loading configuration.

Radio effects that impact AGC control loop operation include without limitation channel fading, and Doppler effects. Channel fading generally relates to the attenuation experienced by an RF signal as it propagates between the transmitter and the receiver. Fading can be greatly affected by considerations such as distance, humidity, physical objects (which may be permeable, semi-permeable, or altogether impermeable, to an RF signal), etc. Moreover, any relative movement between the transmitter and receiver can impart so-called “Doppler” spread. Specifically, Doppler spread manifest as an apparent distortion in signal frequency which is observed at the receiver. Doppler spread further exacerbates fading effects of any wireless channel.

Additionally, physical design constraints may affect AGC control loop operation. In fact, the overall performance of a radio receiver may be significantly affected by even one or two component limitations. For example, some components such as analog-to-digital converters (ADC) have an associated “dynamic range”; signals which exceed the dynamic range are “saturated”, and signals which are too small will be lost in the quantization noise floor.

Still other external elements which may affect AGC operation include so-called “jammers”. Any RF emissions which cannot be fully filtered or removed from the spectrum of interest is considered a jammer. Jammers can introduce significant bias to AGC control loop operation, resulting in skewed gain corrections.

Existing AGC tracking loop implementations must balance requirements for wide dynamic ranges, varying signal characteristics, and receiver specific operation. For these reasons, AGC control parameters have broad impacts on AGC performance.

### Doppler Estimation—

As previously alluded to, in a dynamic wireless environment, Doppler effects can greatly affect transceiver operation. Accordingly, many wireless technologies employ Doppler estimation to determine the overall Doppler spread encountered by transceivers having a relative velocity between one another. It can be empirically shown that Doppler spread is directly proportional to a channel time correlation. In other words, the faster a transceiver moves (such as an LTE user equipment (UE)) with respect to another device (e.g., an evolved NodeB (eNB)), the greater the perceived Doppler spread, which results in shorter channel correlation times. Channel correlation time is used during the channel processing and noise estimation; thus, shorter correlation times have a direct impact on downlink (DL) demodulation (e.g., traffic and control channels).

There are multiple existing schemes for estimating Doppler spread. The most common schemes are based on channel time auto-correlation, and maximum likelihood estimation.

Channel time auto-correlation has a mathematical relationship to Doppler spread, which can be theoretically determined and/or simulated. Thus, instead of estimating the Doppler spread, the transceiver can use channel time autocorrelation estimates to identify the corresponding Doppler spread. Generally, the relationships between autocorrelation estimates and Doppler spread can be performed ahead of time, and stored within a look-up table (or similar) for use during operation.

Alternately, maximum likelihood estimation can be used to determine Doppler spread based on measured power spectral density (PSD), where the PSD of a fading channel indicates the amount of energy received as a function of spectrum (frequency). Existing UEs can measure the PSD using channel estimations derived from pilot signals. The resulting channel estimations can be used to reconstruct a distorted PSD. The distortion in the PSD (from the expected PSD) can be used to identify the corresponding Doppler shift based on a maximum likelihood estimation (using known distortion effects of different Doppler shifts).

### Methods—

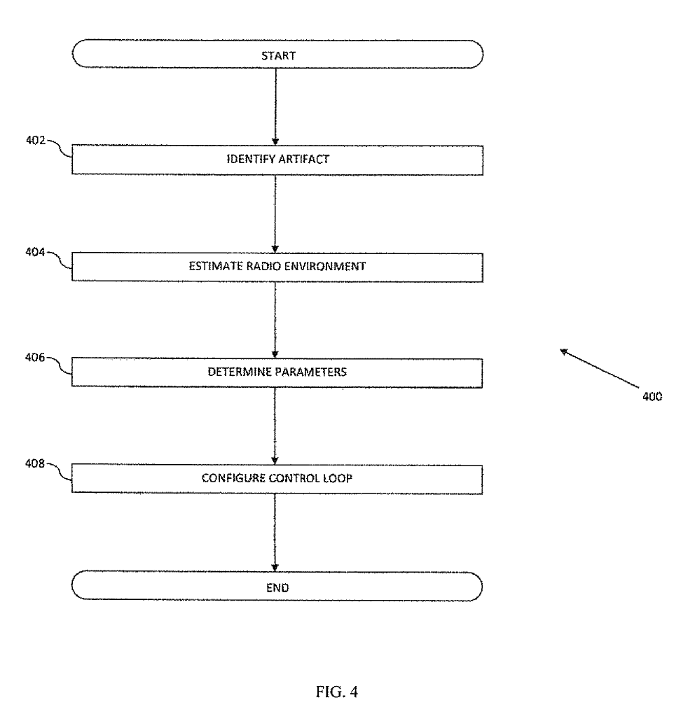

FIG. 4 depicts one generalized method for adjusting adaptive control loop behavior based on measured artifacts of the radio environment. In one exemplary embodiment, a Doppler-dependent adaptive Automatic Gain Control (AGC) algorithm optimizes one or more AGC parameters (e.g., AGC loop gain, AGC set point, etc.) based on an estimation of perceived Doppler spread.

Existing solutions for AGC leave significant margin or “headroom” to account for large changes due to signal variations and channel fading. For example, in LTE transceivers, acceptable design margins must be capable of handling PAPR (peak-to-average power ratio) requirements for Orthogonal Frequency Division Multiplexing (OFDM) signals with time-domain channel fading. Generally, the PAPR is usually around 9-10 decibels (dB), and channel fading can experience swings as large as 20 dB. At the same time, in order to support high data rates (e.g., 64 QAM modulation and/or large code rates), the transceiver Signal to Noise Ratio (SNR) requirements can exceed 30 dB.

Transceiver designs traditionally accomplish the foregoing requirements by increasing sample resolution (increasing the data widths and complexity), which results in more complex hardware (HW) and more power consumption.

In contrast, various embodiments of the present disclosure can use Doppler spread information to identify channel variation. By intelligently adapting to channel variation dynamically, the receiver can optimize the AGC parameters to improve tracking performance, while also advantageously relaxing margin requirements. These improvements result in higher effective Signal-to-Quantization-plus-Noise Ratio (SQNR), which improve demodulation performance, and/or reduce overall design complexity (i.e., reductions in die size and power consumption). Specifically, by ensuring that control loop behavior is specifically targeted to the current Doppler spread, the control loop does not have to be as conservative with safety margins, or as responsive in tracking capabilities. These more lax requirements translate to less complex circuitry, reduced die size, and reduced power consumption (one or more of which can also lead to reduced production cost of the host user device, and enhanced user satisfaction and experience).

Referring back to FIG. 4, at step 402, a receiver receives one or more input(s) to identify one or more artifacts of a radio environment. In one exemplary embodiment, a Long Term Evolution (LTE) user equipment (UE) receives samples of analog data to determine the Doppler spread observed by the UE.

In one implementation, the received inputs are a wideband signal seen at the input of a Radio Frequency (RF) Automatic Gain Control (AGC) (RAGC) loop, such as that of FIG. 3A. The input RF signals are received before the RF signals are down-sampled to the sampling rate utilized in the digital domain of the UE.

In another approach, the received inputs are digital samples received at a digital variable gain control (DVGA) loop of FIG. 3A. In one variant, the data samples have been converted to digital signals through the use of an analog-to-digital converter (ADC).

In some embodiments, the receiver determines Doppler (and hence spread) on the basis of movement (e.g., based on accelerometer operation, positioning systems (Global Positioning System (GPS), A-GPS, etc.). For example, acceleration and/or velocity data (e.g., change in position per unit time, assuming a fixed location base station) can be used to determine the Doppler. Similarly, acceleration integrated over time will yield a velocity corresponding to a Doppler effect. Still other schemes for determining Doppler effects will be recognized by those of ordinary skill, given the contents of the present disclosure.

At step 404, the receiver estimates artifacts of the radio environment from the received one or more input(s).

In one exemplary embodiment, the receiver determines a Doppler spread based on one or more received data. In one variant, Doppler spread is determined based on a channel time auto-correlation of the received inputs. In another variant, the Doppler spread is determined based on a measured power spectral density (PSD) of the one or more received data. Both of which are discussed in more detail in A Statistical Theory of Mobile Radio Reception. Stephen H. Clark. Bell Systems Technical Journal 47 (6): 957-1000, 1968, which is incorporated by reference in its entirety. More directly, where received data has a known “pattern” (e.g., a pilot sequence, learning sequence, etc.), the receiver can estimate an amount of Doppler by comparing an expected data against the actual received data. The resulting difference may be attributed to Doppler effects. In some cases, the receiver may perform a “guess-and-check” scheme, by comparing the received data against one or more expected data which have been adjusted by a hypothetical Doppler effect, etc.

In still other embodiments, artifacts may include the presence of excessive and/or intermittent jamming. In certain variants, jamming may be determined on the basis of spectral analysis. For example, the signal spectrum at a higher sampler frequency can be evaluated that includes not only one or more signal bandwidths of interest, but also the adjacent channels next to the intended signals, based on which jamming detection algorithms can be derived. Moreover, another approach to determine if a strong hammer is present includes evaluating power estimation of received data samples that include both signal and jammer contribution. As another example, certain known jammers may have well-established behaviors e.g., a microwave oven, nearby competing wireless technologies (e.g., Wi-Fi, Bluetooth, etc.). Alternately, jamming may be identified via out-of-band methods. For example, a user may be able to configure their device operation to adjust for specific jamming environments, such as where the user may know in advance that jamming signals are present.

At step 406, the receiver determines one or more parameters for adaptive control loop behavior based on the estimated/measured one or more artifacts of the radio environment.

In one exemplary embodiment, the LTE UE determines a set point and loop gain of an AGC loop. In alternative embodiments, the UE determines one or more time constants for the AGC loop, where the time constant controls the tracking speed of the AGC loop. For instance, the time constant of a single pole infinite impulse response (IIR) filter control loop is a linear function of the inverse of the IIR filter coefficient. Those of ordinary skill in the related arts will readily appreciate that the set point is the target value that the loop will attempt to correct to. The loop gain determines the amount of correction the loop can perform in each iteration, and the time constant controls the frequency of iterations. For example, large loop gain values may result in increased likelihood of overshoot, whereas smaller loop gain values will be unable to properly track large swings in gain. Similarly, a shorter time constant improves loop response, however larger time constants reduce power consumption and erratic swings.

In one implementation, the one or more parameters of step 406 are pre-determined, and stored within a memory component or data structure, such as e.g., a look-up table. In other implementations, the one or more parameters are determined dynamically by the UE, such as via indigenous logic and equipment. In still other approaches, the one or more parameters (or information sufficient to derive them indigenously) may be received from another device (e.g., a base station, another “peer” UE operating within the same network, etc.).

In still other embodiments, the parameters may additionally include one or more considerations based on user (or device) preference, network preference, etc. For example, a user (or an indigenous optimization process within the UE) may wish to maximize data link performance (e.g., speed), or alternately reduce power consumption. Based on the user/device preference (or selection), the device may select a set of parameters accordingly.

At step 408, the receiver configures the adaptive control loop according to the determined one or more parameters.

### Example Operation—

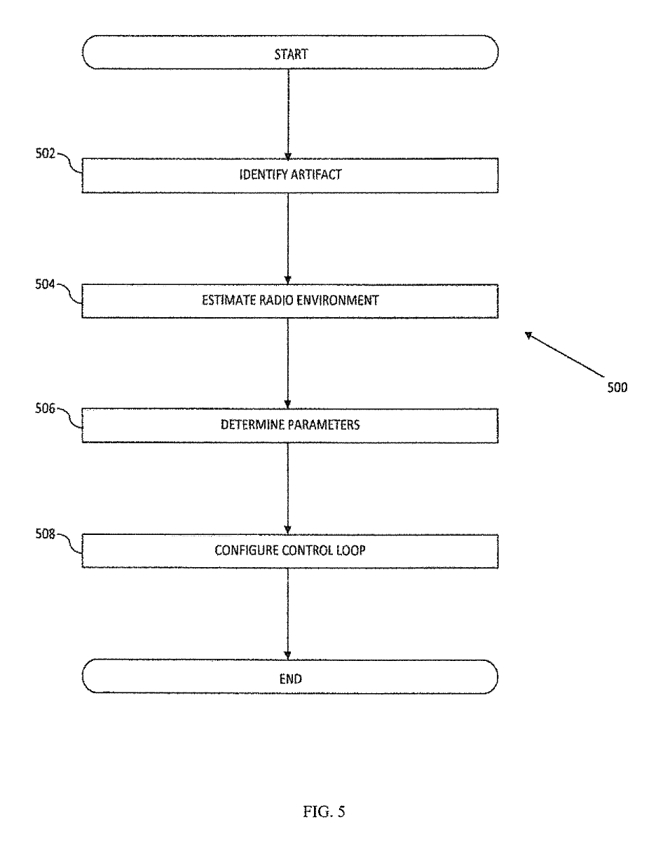

Referring now to FIG. 5, one exemplary method 500 for configuring Adaptive Automatic Gain Control (AGC) based on Doppler spread observed by a wireless receiver is shown and described. In one embodiment, a Long Term Evolution (LTE) user equipment (UE) receives samples of analog data to determine the Doppler spread observed by the UE (or by another observing entity).

In one exemplary implementation, the UE includes a look-up table or other data structure which contains AGC parameters (AGC loop gain and AGC set point), referenced according to Doppler shift indices (or “bins”). In one such variant, the look-up table is populated ahead of time (e.g., at time of manufacture, etc.), although it will be recognized that other approaches (such as dynamic or “on the fly” population, periodic updates, etc.) may be utilized consistent with the disclosure. During operation, the UE can select the Doppler frequency within the data structure closest to its actual observed Doppler frequency (or by other mechanisms, such as e.g., interpolation) to determine the appropriate parameters.

As a brief aside, appropriate AGC parameters can be determined with: (i) theoretical analysis, (ii) simulation (such as via a computer simulation algorithm or package), (iii) in situ (such as via actual field measurements and analysis), and/or (iv) empirical determination, such as within a laboratory or other environment.

Regarding theoretical analysis schemes, as previously indicated, AGC loop gain has a fixed mathematical relationship to the time constant of AGC loops. The time constant of the AGC loops determines how long a channel stays correlated. Thus, for different Doppler frequencies, the appropriate time constant that sustains a channel correlation for a minimum time requirement can be calculated. The exemplary look-up table is in one implementation populated with parameters that support a minimum required de-correlation time for a set of Doppler frequencies.

In contrast to theoretical schemes, simulation and/or empirical determination schemes can identify appropriate AGC parameters, such as with “brute force” analysis. Specifically, the parameters can be derived by running different combinations of Doppler shift configuration, AGC set point and AGC loop gains, and selecting parameters that maximize the throughput.

At step 502 of the method 500, the UE estimates an observed Doppler shift, using pilot signals to evaluate how fast the channel changes. In one variant, the UE calculates one or more channel autocorrelation values which identify an estimated Doppler frequency (f_{d}). Illustrative examples of such calculations are discussed in A Statistical Theory of Mobile Radio Reception. Stephen H Clark Bell Systems Technical Journal 47 (6): 957-1000, 1968, the foregoing being previously incorporated by reference in its entirety.

At step 504, the UE references the look-up table based on the estimated Doppler frequency (f_{d}), and selects the appropriate parameters (AGC parameters such as AGC loop gain and AGC set point).

At step 506, the UE programs the AGC control loop with the selected parameters. At step 508, the UE receives data, and returns to step 502 to continue operation.

### Exemplary Mobile Apparatus—

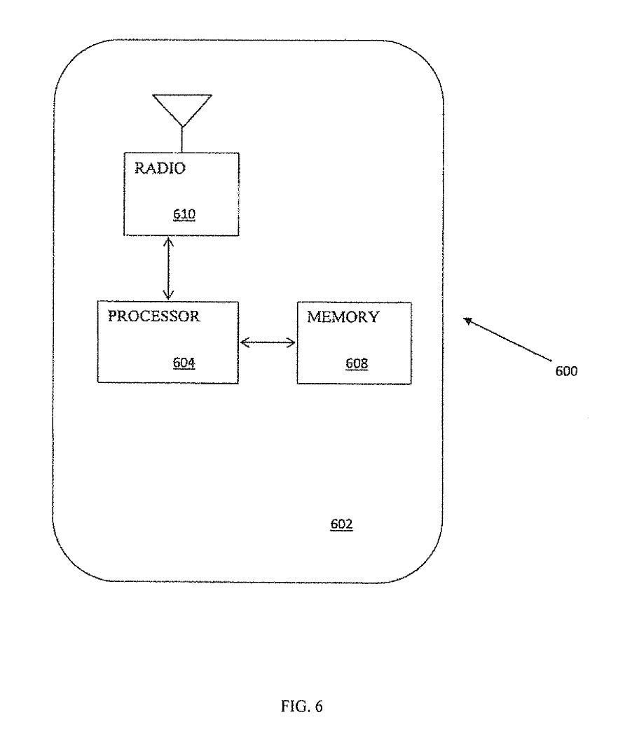

Referring now to FIG. 6, exemplary client (e.g., UE) apparatus 600 implementing the methods and apparatus of the present disclosure is illustrated.

The UE apparatus 600 includes a processor subsystem 604 such as a digital signal processor, microprocessor, field-programmable gate array, or plurality of processing components mounted on one or more substrates 602. The processing subsystem may also comprise an internal cache memory. The processing subsystem 604 is in data communication a memory subsystem 608 comprising memory which may for example, comprise SRAM, Flash and SDRAM components. The memory subsystem may implement one or a more of DMA type hardware, so as to facilitate data accesses as is well known in the art.

The radio/modem subsystem 610 comprises a digital baseband, analog baseband, TX frontend and RX frontend. The apparatus 600 further includes an antenna assembly to receive service from one or more base station devices 600. While specific architecture is discussed, in some embodiments, some components may be obviated or may otherwise be merged with one another (such as RF RX, RF TX and ABB combined, as of the type used for 3G digital RFs) as would be appreciated by one of ordinary skill in the art given the present disclosure.

The apparatus may further include optional additional peripherals including, without limitation, one or more GPS transceivers, or network interfaces such as IrDA ports, Bluetooth, WLAN, and/or WiMAX transceivers, USB, FireWire, etc. It is however recognized that these components are not required for operation of the UE in accordance with the principles of the present disclosure.

In the illustrated embodiment, the modem subsystem additionally includes a database subsystem or module configured to store one or more parameters useful for adjusting adaptive control loop behavior as described supra. In one such variant, the one or more parameters are stored within a look-up table and further referenced according to a measurable artifact e.g., Doppler shift.

In the illustrated embodiment, the modem subsystem additionally includes subsystems or modules configured to estimate an observed Doppler shift, reference the database subsystem or module to determine the appropriate one or more parameters useful for adjusting adaptive control loop behavior, and adjust one or more adaptive control loops based on the determined one or more parameters.

It will be recognized that while certain embodiments of the disclosure are described in terms of a specific sequence of steps of a method, these descriptions are only illustrative of the broader methods described herein, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure.

While the above detailed description has shown, described, and pointed out novel features of the principles described herein, it will be understood that various omissions, substitutions, and changes in the form and details of the device or process illustrated may be made by those skilled in the art without departing from the disclosure. The foregoing description is of the best mode presently contemplated. This description is in no way meant to be limiting, but rather should be taken as illustrative of the general principles. The scope of the disclosure should be determined with reference to the claims.

1. Wireless mobile apparatus, comprising:
a wireless interface configured with an adaptive control loop;
a processor in data communication with the wireless interface; and
logic in data communication with the processor and configured to cause the wireless mobile apparatus to select one or more automatic gain control (AGC) parameters associated with the adaptive control loop based on one or more detected Doppler-related artifacts of a radio environment in which the mobile apparatus operates, the one or more AGC parameters configured to optimize both (i) AGC dynamic range, and (ii) signal-to-quantization-plus-noise ratio (SQNR) of the wireless interface under dynamic wireless fading conditions.

2. The apparatus of claim 1, wherein the interface comprises a long term evolution (LTE) enables wireless interface, and one or more AGC parameters comprise at least one of set-point and loop again.

3. The apparatus of claim 1, wherein the one or more detected Doppler-related artifacts comprises a Doppler spread.

4. The apparatus of claim 1, wherein the logic is further configured to cause the wireless mobile apparatus to perform the selection of the one or more AGC parameters in a dynamic fashion based on changes in the radio environment.

5. The apparatus of claim 4, wherein the adaptive control loop comprises a lower performance design than that required where said dynamic selection of the one or more AGC parameters is not used.

6. The apparatus of claim 5, wherein the lower performance design comprises slower tracking than that required where said dynamic selection of the one or more AGC parameters is not used.

7. The apparatus of claim 1, wherein the adaptive control loop comprises (i) a radio frequency (RF) AGC (RAGC), and (ii) a digital variable gain amplifier (DVGA).

8. The apparatus of claim 7, wherein the RAGC is configured to control a low noise amplifier (LNA) so as to optimize Signal to Noise Ratio (SNR) of a received signal, and the DVGA is configured to adjust a signal level of a digitalized input signal.

9. A method for adjusting adaptive control loop behavior, comprising:
receiving one or more inputs;
estimating one or more artifacts of a radio environment based on the received one or more inputs;
determining one or more parameters configured to enable adaptive control loop behavior based on the estimated one or more artifacts of the radio environment; and
configuring an adaptive control loop according to the determined one or more parameters.

10. The method of claim 9, wherein the estimating the one or more artifacts comprising estimating one or more artifacts related to Doppler-dependent fading.

11. The method of claim 10, wherein the determining the one or more parameters comprises determining one or more automatic gain control (AGC) parameters in dynamic fashion based on changes in the radio environment.

12. The method of claim 9, wherein the receiving of the one or more inputs comprises receiving a wideband radio frequency (RF) signal at an input of an analog portion of the adaptive control loop.

13-18. (canceled)

19. A computed-readable storage apparatus having a non-transitory storage medium with at least one computer program stored thereon, the at least one program that, when executed on a processing apparatus of a wireless device having an adaptive control loop, cause the wireless device to:
receive one or more radio frequency inputs;
determine one or more artifacts of a radio environment based on the receive on or more inputs;
determine one or more parameters that enable adaptive control loop behavior based on the determined one or more artifacts of the radio environment;
configure an adaptive control loop according to the determined one or more parameters; and
perform the determination of the one or more artifacts at least periodically so as to dynamically adjust the adaptive control loop for a prevailing radio environment.

20. (canceled)
